(19) United States
(12) Patent Application Publication
(10) Pub. No.: US 2026/0360300 A1
(43) Pub. Date: Nov. 12, 2026

(54) DRIVING CIRCUIT OF DISPLAY APPARATUS, AND DISPLAY APPARATUS

(71) Applicant: LEDMAN OPTOELECTRONIC CO., LTD, Shenzhen (CN)

(72) Inventors: Mantie LI, Shenzhen (CN); Youming Gan, Shenzhen (CN); Gaoping Gong, Shenzhen (CN)

(73) Assignee: LEDMAN OPTOELECTRONIC CO., LTD, Shenzhen (CN)

(21) Appl. No.: 19/142,069

(22) PCT Filed: Oct. 11, 2023
(86) PCT No.: PCT/CN2023/123941

§ 371 Date: Jun. 20, 2025

(30) Foreign Application Priority Data
Dec. 21, 2022 (CN) 202223439381.2

(51) Int. Cl. G09G 3/32

(52) U.S. Cl. CPC G09G 3/32; G09G 2310/0267; G09G 2310/027; G09G 2320/064; G09G 2330/021

(57) ABSTRACT

A driver circuit of the display device and a display device are provided. The driver circuit of the display device includes a first row driver module which is connected to positive electrodes of each of red display elements, and the first row driver module is configured to receive a first operating voltage and provide a first scanning signal to the red display elements in each row. The driver circuit also includes a second row driver module which is connected to positive electrodes of each of green display elements and positive electrodes of each of blue display elements, and the second row driver module is configured to receive a second operating voltage and provide a second scanning signal to the green display elements in each row and the blue display elements in each row.

### CROSS-REFERENCE TO RELATED APPLICATIONS

This application is an U.S. national phase application under 35 U.S.C. § 371 based upon international patent application No. PCT/CN2023/123941, filed on Oct. 11, 2023, which claims priority to Chinese patent application No. 202223439381.2, filed on Dec. 21, 2022. The contents of the above identified applications are hereby incorporated herein in their entireties by reference.

### TECHNICAL FIELD

The present disclosure relates to the technical field of display technology, in particular to a driver circuit of a display device and a display device.

### BACKGROUND

LED display screens use Light-Emitting Diodes (LEDs) as basic light-emitting elements (pixels). On state and off state or brightness level of each pixel is controlled by a control circuit and a driver circuit, enabling the display screens with relevant pixels to show various information as required by people. The LED display screens have advantages such as wide applicable scope, bright colors, high brightness, and good stability, and are widely used in fields such as advertising, information release, and sports competitions.

However, LED display screens generally include red, green, and blue LEDs. The three-primary-color LEDs have different forward voltage drops. The forward voltage drop of red LEDs is usually lower than that of the green and blue LEDs. In order to accommodate the operation characteristics of the three-primary-color LEDs, a 5V voltage is generally used to power the three-primary-color LEDs. Since the forward voltage drop of the red LEDs is lower than that of the blue and green LEDs, for the purpose of protecting the red LEDs and the drivers of corresponding columns, a resistor is usually connected in series between the negative electrode of the red LED and the driver of the corresponding column to divide the voltage and heat. However, it will increase useless power loss and generate a large amount of heat, thereby increasing the overall temperature of the LED display screens and accelerating the aging of components.

### SUMMARY

The present disclosure provides a driver circuit of a display device. The display device includes a plurality of pixel units arranged in rows and columns. Each of the pixel units includes a red display element, a green display element, and a blue display element. Negative electrodes of display elements of the same color arranged in the same column are interconnected. The driver circuit of the display device includes a first row driver module connected to positive electrodes of red display elements. The first row driver module is configured to receive a first operating voltage and provide a first scanning signal to the red display elements in each row. The driver circuit of the display device includes a second row driver module connected to positive electrodes of green display elements and positive electrodes of blue display elements. The second row driver module is configured to receive a second operating voltage and provide a second scanning signal to the green display elements in each row and the blue display elements in each row. The driver circuit of the display device includes a power supply module connected to the first row driver module and the second row driver module. The power supply module is configured to output the first operating voltage to the first row driver module, and the second operating voltage to the second row driver module.

In an embodiment, the power supply module includes a first switching power supply unit. An input terminal of the first switching power supply unit is configured to receive an external alternating current. The first switching power supply unit is configured to output a supply voltage according to the external alternating current. The power supply module includes a first voltage regulation unit. An input terminal of the first voltage regulation unit is connected to an output terminal of the first switching power supply unit. The first voltage regulation unit is configured to receive the supply voltage and output the first operating voltage to the first row driver module according to the supply voltage. The power supply module includes a second voltage regulation unit. An input terminal of the second voltage regulation unit is connected to an output terminal of the first switching power supply unit. The second voltage regulation unit is configured to receive the supply voltage and output the second operating voltage to the second row driver module according to the supply voltage.

In an embodiment, the supply voltage is greater than the first operating voltage and the first operating voltage is less than or equal to the second operating voltage.

In an embodiment, the first voltage regulation unit and the second voltage regulation unit individually include a DC/DC circuit.

In an embodiment, the power supply module includes a second switching power supply unit. A first output terminal of the second switching power supply unit is connected to the second row driver module. An input terminal of the second switching power supply unit is configured to receive an external alternating current. The second switching power supply unit is configured to output the second operating voltage according to the external alternating current. The power supply module includes a third voltage regulation unit. An input terminal of the third voltage regulation unit is connected to a second output terminal of the second switching power supply unit. The third voltage regulation unit is configured to receive the second operating voltage and output the first operating voltage to the first row driver module according to the second operating voltage.

In an embodiment, the third voltage regulation unit includes a DC/DC circuit.

In an embodiment, the first row driver module includes a plurality of first row channels configured to be in one-to-one correspondence with a plurality of rows of pixel units. Positive electrodes of the red display elements in each row of the pixel units are connected to the corresponding first row channels.

In an embodiment, the second row driver module includes a plurality of second row-channels configured to be in one-to-one correspondence with a plurality of rows of the pixel units. Positive electrodes of the green display elements and the blue display elements in each row of the pixel units are connected to the corresponding second row-channels.

In an embodiment, the driver circuit of the display device further includes a column driver module connected to negative electrodes of the display elements of the same color in each column and a power supply module, and configured to receive the second operating voltage and provide a column driving signal to the display elements in each column.

The present disclosure further provides a display device including the driver circuit of the display device as mentioned in any one of the above embodiments.

### BRIEF DESCRIPTION OF THE DRAWINGS

In order to more clearly illustrate the technical solutions in the embodiments of the present disclosure or in the conventional art, the following will briefly introduce the accompanying drawings required for describing the embodiments or the conventional art. Obviously, the drawings described below involve only some embodiments of the present disclosure, and those skilled in the art can also obtain other drawings based on these drawings without inventive efforts.

FIG. 1 is a first schematic structural diagram of a driver circuit of a display device provided in an embodiment.

FIG. 2 is a second schematic structural diagram of a driver circuit of a display device provided in an embodiment.

FIG. 3 is a third schematic structural diagram of a driver circuit of a display device provided in an embodiment.

FIG. 4 is a fourth schematic structural diagram of a driver circuit of a display device provided in an embodiment.

FIG. 5 is a fifth schematic structural diagram of a driver circuit of a display device provided in an embodiment.

### DETAILED DESCRIPTION

For convenience of understanding, the present disclosure will be described more comprehensively with reference to the relevant accompanying drawings. Some embodiments of the present disclosure are shown in the drawings. However, the present disclosure may be implemented in many different manners and is not limited to the embodiments described herein. On the contrary, these embodiments are provided to make the present disclosure more thorough and complete.

Unless otherwise defined, all technical and scientific terms used herein have the same meaning as commonly understood by those skilled in the art in the technical field of the present disclosure. The terms used in the specification of the present disclosure are merely for describing specific embodiments and are not intended to limit the present disclosure.

As used herein, the singular forms “a”, “an”, and “the” shall include plural forms unless the context clearly dictates otherwise. It should also be understood that terms such as “include/comprise” or “have” specify the presence of stated features, integers, steps, operations, components, parts, or combinations thereof, but do not preclude the presence or addition of one or more other features, integers, steps, operations, components, parts, or combinations thereof. Meanwhile, the term “and/or” in this specification includes any and all combinations of the related listed items.

The present disclosure provides a driver circuit for a display device. The display device includes multiple pixel units arranged in rows and columns. Each of the pixel units includes a red display element, a green display element, and a blue display element. The negative electrodes of the display elements having the same color in the same column are interconnected.

Each of the display elements is a Light-Emitting Diode (LED). An LED is a solid-state semiconductor device capable of converting electrical energy into visible light. The internal semiconductor chip of the LED consists of two parts. One of the parts is a P-type semiconductor, and the other part is an N-type semiconductor. When the two semiconductors are connected, a PN junction is formed. When current is applied to the chip through a wire, electrons are driven to the P region, where electrons recombine with holes and energy are emitted in the form of photons, thus lighting the LED. The red, green, and blue display elements can form a pixel unit as a display unit of the display device, thereby presenting various colors. In addition, multiple pixel units arranged in an array form an LED display module. The approaches for driving the LED display module mainly include static driving and scanning driving. The static driving refers to that the positive electrodes of all display elements of each of the pixel units are connected to the voltage input terminal of the LED display module, while the negative electrodes of all display elements are connected to a column driver integrated circuit (IC). The static driving does not require a row driver IC. The scanning driving refers to that the positive electrodes of all display elements in the same row of the pixel units are connected in parallel and electrically connected to a row driver IC. Meanwhile, the negative electrodes of all display elements in the same column of the pixel units are connected in parallel and electrically connected to a column driver IC. Since the row driver IC has a certain voltage drop, the input voltage applied to the row driver IC can be within 4.5V to 5V to ensure that different regions of the LED display module do not exhibit color differences due to voltage drop. However, since the positive electrodes of all display elements in the same row are connected in parallel, each of the display elements in the same row receives the same voltage.

However, the forward voltage drop of a red display element is generally 1.8V to 2.4V, while that the forward voltage drop of a green display element or a blue display element is generally 2.4V to 3.6V. For protection of the display elements and the column driver IC, a resistor is generally connected in series between the red display element and the column driver IC to divide the voltage and heat. However, this approach increases useless power loss. When the LED display module has a large designed area or high designed brightness, the power loss of the LED display module also increases. Firstly, the power loss in the wires between an external power supply and the LED display module is exacerbated. Secondly, it is necessary to use thicker power wires, increasing component costs. Therefore, the present disclosure separately powers the positive electrodes of the red display elements and the positive electrodes of the green and blue display elements to overcome the defects caused by the aforementioned single voltage input.

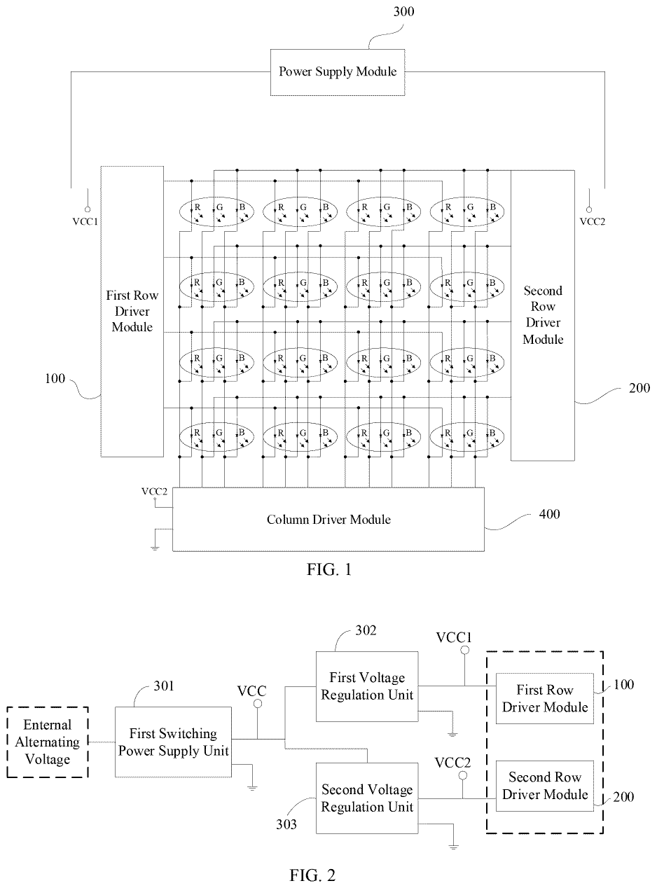

Furthermore, referring to FIG. 1, the driver circuit of the display device includes a first row driver module 100, a second row driver module 200, and a power supply module 300.

The first row driver module 100 is connected to the positive electrodes of the red display elements. The first row driver module 100 is configured to receive a first operating voltage and provide a first scanning signal to the red display elements in each row. The second row driver module 200 is connected to the positive electrodes of the green display elements and the blue display elements. The second row driver module 200 is configured to receive a second operating voltage and provide a second scanning signal to the green display elements and the blue display elements in each row. The power supply module 300 is connected to the first row driver module 100 and the second row driver module 200. The power supply module 300 is configured to output the first operating voltage to the first row driver module 100 and the second operating voltage to the second row driver module 200.

It can be understood that in FIG. 1, the red display elements are denoted as R, the green display elements as G, and the blue display elements as B. Since the forward voltage drop of the red display elements is lower than that of the green and blue display elements, the first row driver module 100 is configured to drive the red display elements of each row separately, and the second row driver module 200 is configured to drive the green and blue display elements of each row, so that the voltage drop across each display element is within a reasonable range. Therefore, the resistor connected in series to the negative electrode of each column of red display elements can be removed, reducing power loss and the overall temperature of the display device.

Specifically, the voltage provided by the power supply module 300 to the first row driver module 100 is defined as the first operating voltage VCC1. Optionally, the first operating voltage VCC1 may be 2.8V to 3.0V, which falls within the range of the forward voltage drop of the red display elements during normal operation. The voltage provided by the power supply module 300 to the second row driver module 200 is defined as the second operating voltage VCC2. Optionally, the second operating voltage VCC2 may be 3.8V to 4.0V, which also falls within the range of the forward voltage drop of the green and blue display elements during normal operation. Thus, the positive electrodes of all display elements receive reasonable voltages. Due to the reduction in power loss and the temperature of the display device, the designed brightness of each display element is approximately 10% higher than that of the existing technical solution of single voltage input.

Moreover, since scanning driving is achieved by time-division lighting of display elements in different rows, when the first row driver module 100 and the second row driver module 200 receive a row control signal which is a periodic square wave signal, The first scanning signal output by the first row driver module 100 under the row control signal is a periodic signal. During each time period, only one row of red display elements is driven into the on state. The second scanning signal output by the second row driver module 200 is also a periodic signal that drives the green and blue display elements of only one row to turn on in each time period. Through row-by-row scanning and synchronous changing of the control signals for each column, as long as the scanning frequency is fast enough, a complete image can be seen on the LED display module due to the persistence of vision of human eyes.

In the above example, the red display elements are separately controlled by the first row driver module 100. The first operating voltage is input into the first row driver module 100 to power the red display elements. The green and blue display elements are controlled by the second row driver module 200. The second operating voltage is input into the second row driver module 200 to power the green and blue display elements. By separately powering the red display elements, the voltages across the three-primary-color display elements fall within a reasonable range, thereby reducing the power loss and the temperature of the display device.

In an embodiment, referring to FIG. 1, the first row driver module 100 includes multiple first row channels, which are in one-to-one correspondence with multiple rows of pixel units. The positive electrodes of the red display elements in each row of the pixel units are connected to the corresponding first row channels.

Referring to the display matrix having 4 rows and 4 columns shown in FIG. 1, the positive electrodes of all red display elements in the same row are connected in parallel and electrically connected to a first row channel. The positive electrodes of red display elements in different rows need to be connected to different first row channels.

In an embodiment, the second row driver module 200 includes multiple second row-channels which are in one-to-one correspondence with multiple rows of pixel units. The positive electrodes of the green display elements and the blue display elements in each row of pixel units are connected to the corresponding second row-channels.

All positive electrodes of the green and blue display elements in the same row are connected in parallel and electrically connected to a second row-channel. The positive electrodes of the green and blue display elements in different rows need to be connected to different second row-channels.

In an embodiment, referring to FIG. 1, the driver circuit of the display device further includes a column driver module 400 which is connected to the negative electrodes of the display elements of the same color in each column and the power supply module 300. The column driver module 400 is configured to receive the second operating voltage and provide a column driving signal to the display elements in each column.

The column driver module 400 includes multiple column channels which are in one-to-one correspondence with multiple columns of pixel units. The negative electrodes of the display elements of the same color in each column of pixel units are respectively connected to the corresponding column channel. When the first row driver module 100 and the second row driver module 200 receive a row control signal to drive, in time-division, the display elements of each row into the on state, the column driver module 400 receives a column control signal and provides a column driving signal to the corresponding display elements according to the column control signals to control the brightness of the corresponding display elements. For example, in FIG. 1, it is assumed that the time periods during which the first row driver module 100 and the second row driver module 200 output high-level signals to the positive electrodes of the display elements in the first, second, third, and fourth rows are the first time period, the second time period, the third time period, and the fourth time period. If it is desired to light the red display element R in the second row and second column and the blue display element B in the fourth row and fourth column, it is only necessary to control the column control signal such that the column driver module 400 sets the red column channel of the second column to a low voltage level during the second time period and sets the blue column channel of the fourth column to a low voltage level during the fourth time period, and sets the remaining column channels to a high voltage level during the remaining time periods, thereby achieving the lighting of the target display elements. Meanwhile, the column driver module 400 can also control the brightness of the target display elements by correspondingly controlling the magnitude of the driving current and the duty cycle.

In an embodiment, as shown in FIG. 2, the power supply module includes a first switching power supply unit 301, a first voltage regulation unit 302, and a second voltage regulation unit 303. The input terminal of the first switching power supply unit 301 is configured to receive an external alternating current, and the first switching power supply unit 301 is configured to output a supply voltage according to the external alternating current. The input terminal of the first voltage regulation unit 302 is connected to the output terminal of the first switching power supply unit 301. The first voltage regulation unit 302 is configured to receive the supply voltage and output the first operating voltage to the first row driver module 100 according to the supply voltage. The input terminal of the second voltage regulation unit 303 is connected to the output terminal of the first switching power supply unit 301. The second voltage regulation unit 303 is configured to receive the supply voltage and output the second operating voltage to the second row driver module 200 according to the supply voltage.

It can be understood that the first switching power supply unit 301 includes a first switching power supply, by which a direct current voltage is obtained after stepping down, rectifying, and filtering the external alternating current, and the direct current voltage is transmitted to the output terminal to output the supply voltage VCC. The output terminal also feeds back the magnitude of the output voltage to the input terminal to stably output the supply voltage. In addition, the first switching power supply unit 301 includes two output terminals, one of which is connected to the reference ground, and the other is connected to the first voltage regulation unit 302. The first voltage regulation unit 302 converts the input supply voltage VCC into the first operating voltage VCC1 and powers the first row driver module 100. The other output terminal of the first switching power supply unit 301 is also connected to the second voltage regulation unit 303 which converts the input supply voltage VCC into the second operating voltage VCC2 and powers the second row driver module 200.

In an embodiment, the supply voltage is greater than the first operating voltage. The first operating voltage is less than or equal to the second operating voltage.

Optionally, the supply voltage VCC may be configured to, such as, 12V, 24V, 36V, or 48V. The first operating voltage VCC1 may be in the range of 2.8V to 3.0V. The second operating voltage VCC2 may be in the range of 3.8V to 4.0V. By configuring the supply voltage VCC to be greater than the first operating voltage VCC1 and the supply voltage VCC to be greater than the second operating voltage VCC2, the supply voltage VCC is input at a high voltage, which reduces the current and thus the size of the power wires can be reduced, facilitating cost savings of components, and the voltage drop of the wires does not affect the voltage drop of display terminals. The first operating voltage VCC1 is less than or equal to the second operating voltage VCC2, which ensures that the forward voltage drops of the three-primary-color display elements are respectively within appropriate ranges, making the voltage drops across each display element more reasonable.

In an embodiment, the first voltage regulation unit and the second voltage regulation unit each include a DC/DC circuit. The DC/DC circuit can convert a fixed Direct Current (DC) voltage into an adjustable DC voltage, and also has the characteristics of voltage stabilization, current stabilization, power control, and DC line protection. Accordingly, the first voltage regulation unit can stably step down the supply voltage VCC to the first operating voltage VCC1 by using the DC/DC circuit, and the second voltage regulation unit can also stably step down the supply voltage VCC to the second operating voltage VCC2 by using the DC/DC circuit.

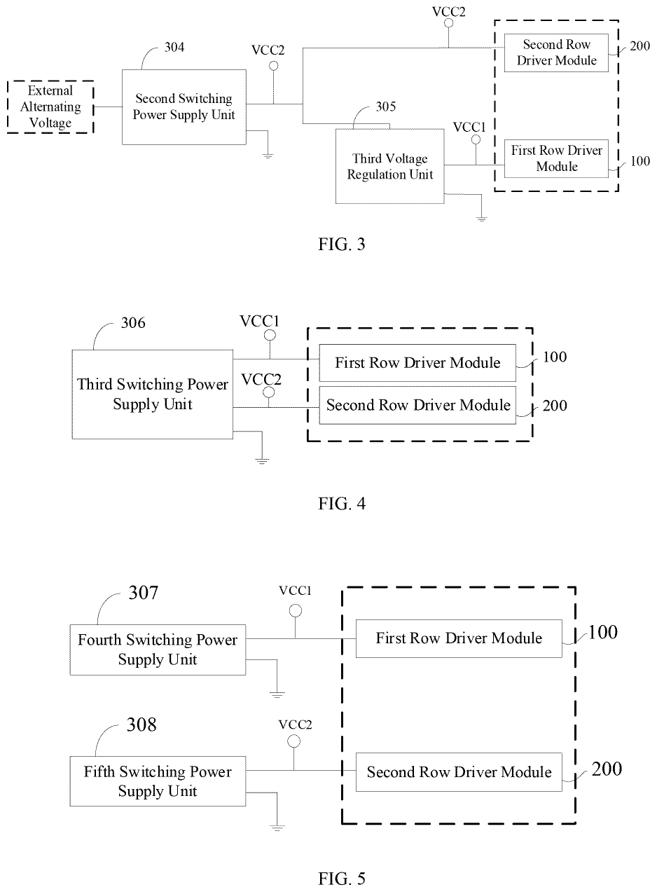

In an embodiment, as shown in FIG. 3, the power supply module includes a second switching power supply unit 304 and a third voltage regulation unit 305. The first output terminal of the second switching power supply unit 304 is connected to the second row driver module 200. The input terminal of the second switching power supply unit 304 is configured to receive an external alternating current. The second switching power supply unit 304 is configured to output the second operating voltage according to the external alternating current. The input terminal of the third voltage regulation unit 305 is connected to the second output terminal of the second switching power supply unit 304. The third voltage regulation unit 305 is configured to receive the second operating voltage and output the first operating voltage to the first row driver module 100 according to the second operating voltage.

It can be understood that the second switching power supply unit 304 includes a second switching power supply which converts the external alternating current into DC voltage for output. The second switching power supply unit 304 includes three output terminals. The first output terminal is connected to the second row driver module 200 to use the output DC voltage as the second operating voltage VCC2 to power the second row driver module 200. The second output terminal is connected to the third voltage regulation unit 305 which converts the input second operating voltage VCC2 into the first operating voltage VCC1 and powers the first row driver module 100. The third output terminal is connected to the reference ground. The second operating voltage VCC2 is greater than or equal to the first operating voltage VCC1. Optionally, the first operating voltage VCC1 may be in the range of 2.8V to 3.0V. The second operating voltage VCC2 may be in the range of 3.8V to 4.0V. In other embodiments, the third voltage regulation unit includes a DC/DC circuit, and the third voltage regulation unit can stably step down the second operating voltage VCC2 to the first operating voltage VCC1 by using the DC/DC circuit.

Due to the change in the internal structure of the power supply module, the sources of the first operating voltage VCC1 and the second operating voltage VCC2 change, but the forward voltage drops across each display element can still meet their respective conduction voltage drop ranges, which can effectively reduce the useless power loss, effectively reduce the temperature of the display device under the same conditions, allow the use of thinner power wires to reduce application costs, and significantly improve the overall brightness of the device.

In an embodiment, as shown in FIG. 4, the power supply module includes a third switching power supply unit 306 which is respectively connected to the first row driver module 100 and the second row driver module 200. The first output terminal of the third switching power supply unit 306 inputs the first operating voltage VCC1 to the first row driver module 100. The second output terminal of the third switching power supply unit 306 inputs the second operating voltage VCC2 to the second row driver module 200. The third output terminal of the third switching power supply unit 306 is connected to the reference ground.

In an embodiment, as shown in FIG. 5, the power supply module includes a fourth switching power supply unit 307 and a fifth switching power supply unit 308. The fourth switching power supply unit 307 is connected to the first row driver module 100. The first output terminal of the fourth switching power supply unit 307 inputs the first operating voltage VCCI to the first row driver module 100. The second output terminal of the fourth switching power supply unit 307 is connected to the reference ground. The fifth switching power supply unit 308 is connected to the second row driver module 200. The first output terminal of the fifth switching power supply unit 308 inputs the second operating voltage VCC2 to the second row driver module 200. The second output terminal of the fifth switching power supply unit 308 is connected to the reference ground.

The above driver circuit of the display device separately controls the red display elements through the first row driver module and separately powers the red display elements by inputting the first operating voltage to the first row driver module. The device controls the green and blue display elements through the second row driver module and powers the green and blue display elements by inputting the second operating voltage to the second row driver module. By separately powering the red display elements, the voltages across the three-primary-color display elements fall within a reasonable range, thereby reducing the power loss and the temperature of the display device.

The present disclosure also provides a display device including the driver circuit of the display device according to any one of the above embodiments. Based on the above driver circuit of the display device, the display device can significantly improve the overall brightness, effectively reduce useless power loss, and the temperature of the device.

In the description of this specification, references to the terms “some embodiments”, “other embodiments”, “ideal embodiments” and the like mean that a specific feature, structure, material, or characteristic described in connection with the embodiment or example is included in at least one embodiment or example of the present disclosure. In this specification, the schematic representation of the above terms does not necessarily refer to the same embodiment or example.

The technical features of the above embodiments can be combined arbitrarily. To make the description concise, not all possible combinations of the technical features in the above embodiments are described. However, as long as there is no contradiction between the combinations of these technical features, they should be considered as within the scope described in this specification.

The above embodiments only represent several implementations of the present disclosure, and their descriptions are more specific and detailed, but should not be construed as limiting the scope of the present disclosure. It should be noted that, for those skilled in the art, without departing from the inventive concept of the present disclosure, several modifications and improvements can be made, and these all fall within the protection scope of the present disclosure. Therefore, the protection scope of the present disclosure should be subject to the appended claims.

1. A driver circuit of a display device, the display device comprising a plurality of pixel units arranged in rows and columns, each of the pixel units including a red display element, a green display element, and a blue display element, negative electrodes of display elements of the same color arranged in the same column being interconnected, the driver circuit of the display device comprising:
a first row driver module, connected to positive electrodes of red display elements, wherein the first row driver module is configured to receive a first operating voltage and provide a first scanning signal to the red display elements in each row;
a second row driver module, connected to positive electrodes of green display elements and positive electrodes of blue display elements, wherein the second row driver module is configured to receive a second operating voltage and provide a second scanning signal to the green display elements in each row and the blue display elements in each row;
a power supply module, connected to the first row driver module and the second row driver module, wherein the power supply module is configured to output the first operating voltage to the first row driver module, and the second operating voltage to the second row driver module.

2. The driver circuit of the display device according to claim 1, wherein the power supply module comprises:
a first switching power supply unit, wherein an input terminal of the first switching power supply unit is configured to receive an external alternating current, and the first switching power supply unit is configured to output a supply voltage according to the external alternating current;
a first voltage regulation unit, wherein an input terminal of the first voltage regulation unit is connected to an output terminal of the first switching power supply unit, the first voltage regulation unit is configured to receive the supply voltage, and output the first operating voltage to the first row driver module according to the supply voltage;
a second voltage regulation unit, wherein an input terminal of the second voltage regulation unit is connected to an output terminal of the first switching power supply unit, the second voltage regulation unit is configured to receive the supply voltage, and output the second operating voltage to the second row driver module according to the supply voltage.

3. The driver circuit of the display device according to claim 2, wherein the supply voltage is greater than the first operating voltage, and the first operating voltage is less than or equal to the second operating voltage.

4. The driver circuit of the display device according to claim 3, wherein the first voltage regulation unit and the second voltage regulation unit each comprise a DC/DC circuit.

5. The driver circuit of the display device according to claim 1, wherein the power supply module comprises:
a second switching power supply unit, wherein a first output terminal of the second switching power supply unit is connected to the second row driver module, an input terminal of the second switching power supply unit is configured to receive an external alternating current, the second switching power supply unit is configured to output the second operating voltage according to the external alternating current;
a third voltage regulation unit, an input terminal of the third voltage regulation unit is connected to a second output terminal of the second switching power supply unit, the third voltage regulation unit is configured to receive the second operating voltage and output the first operating voltage to the first row driver module according to the second operating voltage.

6. The driver circuit of the display device according to claim 5, wherein the third voltage regulation unit comprises a DC/DC circuit.

7. The driver circuit of the display device according to claim 1, wherein the first row driver module comprises:
a plurality of first row channels, configured to be in one-to-one correspondence with a plurality of rows of pixel units, wherein positive electrodes of the red display elements in each row of the pixel units are connected to the corresponding first row channels.

8. The driver circuit of the display device according to claim 1, wherein the second row driver module comprises:
a plurality of second row-channels, configured to be in one-to-one correspondence with a plurality of rows of the pixel units, wherein positive electrodes of the green display elements and the blue display elements in each row of the pixel units are connected to the corresponding second row-channels.

9. The driver circuit of the display device according to claim 1, wherein the driver circuit of the display device further comprises:
a column driver module, connected to negative electrodes of the display elements of the same color in each column and a power supply module, and configured to receive the second operating voltage and provide a column driving signal to the display elements in each column.

10. A display device, comprising a driver circuit of the display device and a plurality of pixel units arranged in rows and columns, each of the pixel units including a red display element, a green display element, and a blue display element, negative electrodes of display elements of the same color arranged in the same column being interconnected, the device further comprising a driver circuit of the display device comprising:
a first row driver module, connected to positive electrodes of red display elements, wherein the first row driver module is configured to receive a first operating voltage and provide a first scanning signal to the red display elements in each row;
a second row driver module, connected to positive electrodes of green display elements and positive electrodes of blue display elements, wherein the second row driver module is configured to receive a second operating voltage and provide a second scanning signal to the green display elements in each row and the blue display elements in each row;
a power supply module, connected to the first row driver module and the second row driver module, wherein the power supply module is configured to output the first operating voltage to the first row driver module, and the second operating voltage to the second row driver module.

11. The display device according to claim 10, wherein the power supply module comprises:
a first switching power supply unit, wherein an input terminal of the first switching power supply unit is configured to receive an external alternating current, and the first switching power supply unit is configured to output a supply voltage according to the external alternating current;
a first voltage regulation unit, wherein an input terminal of the first voltage regulation unit is connected to an output terminal of the first switching power supply unit, the first voltage regulation unit is configured to receive the supply voltage, and output the first operating voltage to the first row driver module according to the supply voltage;
a second voltage regulation unit, wherein an input terminal of the second voltage regulation unit is connected to an output terminal of the first switching power supply unit, the second voltage regulation unit is configured to receive the supply voltage, and output the second operating voltage to the second row driver module according to the supply voltage.

12. The display device according to claim 11, wherein the supply voltage is greater than the first operating voltage, and the first operating voltage is less than or equal to the second operating voltage.

13. The display device according to claim 12, wherein the first voltage regulation unit and the second voltage regulation unit each comprise a DC/DC circuit.

14. The display device according to claim 10, wherein the power supply module comprises:
a second switching power supply unit, wherein a first output terminal of the second switching power supply unit is connected to the second row driver module, an input terminal of the second switching power supply unit is configured to receive an external alternating current, the second switching power supply unit is configured to output the second operating voltage according to the external alternating current;
a third voltage regulation unit, an input terminal of the third voltage regulation unit is connected to a second output terminal of the second switching power supply unit, the third voltage regulation unit is configured to receive the second operating voltage and output the first operating voltage to the first row driver module according to the second operating voltage.

15. The display device according to claim 14, wherein the third voltage regulation unit comprises a DC/DC circuit.

16. The display device according to claim 10, wherein the first row driver module comprises:
a plurality of first row channels, configured to be in one-to-one correspondence with a plurality of rows of pixel units, wherein positive electrodes of the red display elements in each row of the pixel units are connected to the corresponding first row channels.

17. The display device according to claim 10, wherein the second row driver module comprises:
a plurality of second row-channels, configured to be in one-to-one correspondence with a plurality of rows of the pixel units, wherein positive electrodes of the green display elements and the blue display elements in each row of the pixel units are connected to the corresponding second row-channels.
